(19) United States
(12) Patent Application Publication
(10) Pub. No.: US 2025/0167629 A1
(43) Pub. Date: May 22, 2025

(54) DRIVE UNIT

(71) Applicant: TOYOTA JIDOSHA KABUSHIKI KAISHA, Toyota-shi (JP)

(72) Inventor: Hiroki KUNIFUDA, Chiryu-shi (JP)

(73) Assignee: TOYOTA JIDOSHA KABUSHIKI KAISHA, Toyota-shi (JP)

(21) Appl. No.: 18/884,428

(22) Filed: Sep. 13, 2024

(30) Foreign Application Priority Data
Nov. 20, 2023 (JP) 2023-196992

(51) Int. Cl. H02K 7/116; B60K 1/02; H02K 24/00

(52) U.S. Cl. CPC H02K 7/116; B60K 1/02; H02K 24/00

(57) ABSTRACT

The motor MG (e.g., the first motor MG, the second motor MG) and the gear (e.g., drive gear, driven gear, final gear, differential gear, reduction gear, power split mechanism) a transaxle is a drive device including, PCU for controlling the power supplied and received by the motor MG (=power controller) is housed in the same case, a drive unit, a resolver is a rotational sensor of the motor MG (e.g., the first resolver, the second resolver) wire harness is a wire for sending a detection signal at the resolver to the power control device is disposed only in the case.

### CROSS-REFERENCE TO RELATED APPLICATION

This application claims priority to Japanese Patent Application No. 2023-196992 filed on Nov. 20, 2023, incorporated herein by reference in its entirety.

### BACKGROUND

### 1. Technical Field

The present disclosure relates to a drive unit in which a drive device including a motor and a gear and a power control device that controls power transmitted and received by the motor are housed in the same case.

### 2. Description of Related Art

There is known a drive unit in which a drive device including a motor and a gear and a power control device that controls power transmitted and received by the motor are housed in the same case. For example, Japanese Unexamined Patent Application Publication No. 2022-152851 (JP 2022-152851 A) describes such a unit.

### SUMMARY

In order to suppress the motor, functioning as a power source, going out of synchronism, a resolver as a rotation sensor detects the rotation state of the motor, and the power control device controls rotation of the motor according to the detected rotation state of the motor. The resolver is fixed to the inside of the case. In general, a wire for sending a detection signal from the resolver to the power control device is drawn out of the case from the vicinity of the position at which the resolver is fixed to the case, disposed outside the case, and then drawn into the case that houses the power control device. When the wire is disposed outside the case as described above, however, the length of the wire is increased, which may lead to a deterioration in the mountability (=ease of mounting) of the drive unit on the vehicle and an increase in the cost of the drive unit, for example.

The present disclosure has been made in view of the above circumstances, and an object thereof is to provide a drive unit capable of reducing the length of a wire for sending a detection signal from a resolver to a power control device.

An aspect of the present disclosure provides a drive unit in which a drive device including a motor and a gear and a power control device that controls power transmitted and received by the motor are housed in an identical case, in which a wire for sending a detection signal from a resolver, as a sensor for rotation of the motor, to the power control device is disposed only in the case.

With the drive unit according to the present disclosure, the wire for sending a detection signal from the resolver, as a rotation sensor for the motor, to the power control device is disposed only in the case. The length of the wire for sending the detection signal from the resolver can be reduced when the wire is disposed only in the case, compared to when the wire is disposed outside the case. Consequently, it is possible to improve the mountability of the drive unit on the vehicle, and to suppress an increase in the cost of the drive unit, for example.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a transaxle of a drive unit according to an embodiment of the present disclosure; and

FIG. 2 is a diagram illustrating an exemplary electric configuration of a PCU or the like of a drive unit according to an embodiment of the present disclosure.

### DETAILED DESCRIPTION OF EMBODIMENTS

Hereinafter, examples of the present disclosure will be described in detail with reference to the drawings. Note that, in the embodiments, the drawings are simplified or modified as appropriate, and the dimensional ratios, shapes, and the like of the respective portions are not necessarily drawn accurately.

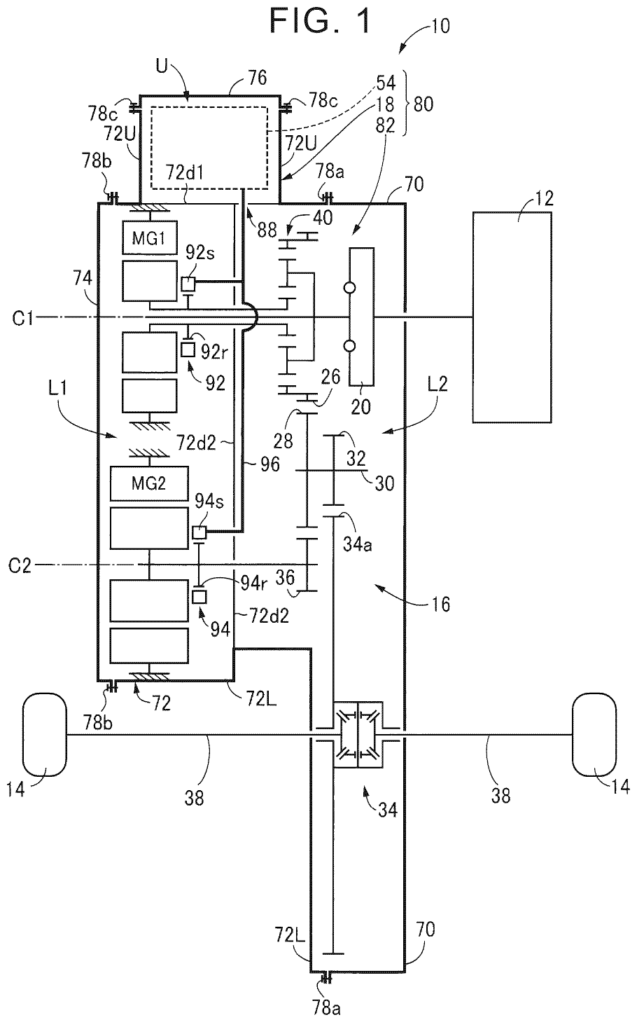

FIG. 1 is a diagram illustrating a configuration of a transaxle 82 of a drive unit 80 according to an embodiment of the present disclosure. The drive unit 80 is a drive unit that causes the vehicle 10 to travel. Note that, in FIG. 1, the transaxle 82 is illustrated as a skeleton view, and the skeleton view is illustrated so as to schematically represent the relative arrangement positions of the components in the transaxle 82.

The vehicle 10 is a hybrid electric vehicle including an engine 12 functioning as a power source, and a first motor MG1 and a second motor MG2 that are motors functioning as a power source. The vehicle 10 includes a pair of drive wheels 14 and a power transmission device 16. The engine 12 is a well-known internal combustion engine. The first motor MG1 and the second motor MG2 are, for example, rotating electric machines having an electric motor function and a generator function, and are so-called motor generators. The first motor MG1 and the second motor MG2 are power sources for driving the vehicles 10, and are, for example, three-phase synchronous motors. The first motor MG1 and the second motor MG2 are housed in a case 18 which is a non-rotating member attached to the vehicle body. For example, the axis C1, which is the rotation center line of the first motor MG1, and the axis C2, which is the rotation center line of the second motor MG2, are parallel to each other. For example, the first motor MG1 and the second motor MG2 are arranged in the up-down direction when the width of the first motor MG1 in the axis C1 direction is shorter than the width of the second motor MG2 in the axis C2 direction. In addition, the range occupied by the first motor MG1 in the axis C1 direction is within the range occupied by the second motor MG2 in the axis C2 direction. This makes it possible to shorten the area occupied by the first motor MG1 and the second motor MG2 in the axis C1 direction (=axis C2 direction). When the first motor MG1 and the second motor MG2 are not particularly distinguished from each other, they are referred to as a motor MG. The “motor MG” corresponds to the “motor” in the present disclosure.

The power transmission device 16 includes, in the power transmission path between the engine 12 and the pair of drive wheels 14, a damper 20, a power split mechanism 40, a drive gear 26, a driven gear 28, a driven shaft 30, a final gear 32, a differential 34 (including a differential ring gear 34a), and the like in order from the engine 12 in the case 18. These are well known configurations. Hereinafter, the power split mechanism 40, the drive gear 26, the driven gear 28, the final gear 32, and the differential 34 will be referred to as a “power split mechanism 40 and the like”. The power transmission device 16 includes a reduction gear 36, a driven gear 28, a driven shaft 30, a final gear 32, a differential 34, and the like in order from the second motor MG2 in the case 18 in the power transmission path between the second motor MG2 and the pair of drive wheels 14. These are well known configurations. The power transmission device 16 includes a pair of axles 38 and the like connected to the differential 34. The output of the power transmission device 16 is transmitted to the pair of drive wheels 14 via a pair of axles 38 and the like connected to the differential 34.

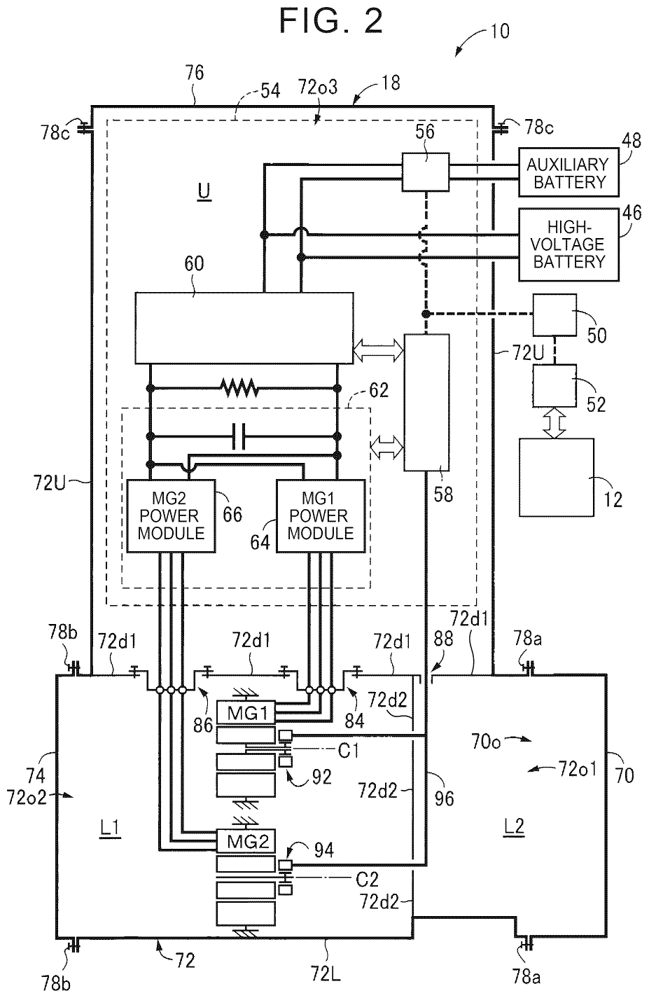

The power split mechanism 40 is constituted by a known single pinion type planetary gear unit. For example, the power outputted from the engine 12 is mechanically divided into the first motor MG1 and the drive gears 26 by the power split mechanisms 40. The first motor MG1 generates electric power by the power of the engine 12 divided into the first motor MG1. The electric power generated by the first motor MG1 is charged in the high-voltage battery 46 (see FIG. 2), or the electric power from the high-voltage battery 46 is used for the rotational driving of the second motor MG2 in addition to all or a part of the generated electric power or the generated electric power. The power split mechanism 40 functions as an electric continuously variable transmission in which the differential state of the power split mechanism 40 is controlled by controlling the operating state of the first motor MG1. The power of the engine 12 divided into the drive gears 26 is transmitted to the driven gear 28, the driven shaft 30, the final gear 32, and the differential 34. The second motor MG2 is connected to the driven shaft 30 via the reduction gear 36 and the driven gear 28 so as to be capable of transmitting power. The first motor MG1 may also function as a power source for outputting power to the pair of drive wheels 14 via the power split mechanism 40.

FIG. 2 is a diagram illustrating an exemplary electric configuration of a PCU54 or the like of the drive unit 80 according to the embodiment of the present disclosure. Note that PCU54 corresponds to a “power control device” in the present disclosure.

The vehicle 10 further includes a high-voltage battery 46, an auxiliary battery 48, and a PCU54. The high-voltage battery 46 is, for example, a rechargeable secondary battery such as a nickel-hydrogen secondary battery or a lithium-ion battery. The high-voltage battery 46 is connected to PCU54. The high-voltage battery 46 is a battery for driving the motor MG. For example, the stored electric power is supplied from the high-voltage battery 46 to the second motor MG2 via PCU54. The motor MG generates electric power by the power of the engine 12 and the driven power inputted from the pair of drive wheels 14, and the generated electric power is charged to the high-voltage battery 46 via PCU54. The auxiliary battery 48 is, for example, a rechargeable secondary battery such as a lead storage battery. The auxiliary battery 48 has a charge voltage lower than that of the high-voltage battery 46. The auxiliary battery 48 is charged by electric power generated by an alternator rotationally driven by the engine 12 and electric power supplied from the high-voltage battery 46 through DCDC converters 56.

PCU54 drives and controls the motor MG. PCU54 includes a DCDC converter 56, a step-up converter 60, an inverter 62, and a motor control unit 58. PCU54 is a power control device that controls electric power transmitted and received between the high-voltage battery 46 and the motor MG, that is, electric power transmitted and received by the motor MG.

DCDC converters 56 are connected to the high voltage battery 46. DCDC converter 56 functions as a charging device that reduces the voltage of the high-voltage battery 46 to a voltage equivalent to that of the auxiliary battery 48 and charges the auxiliary battery 48. The auxiliary battery 48 supplies electric power for operating the auxiliary machine provided in the vehicle 10. The auxiliary battery 48 supplies electric power for operating, for example, the engine control unit 52 and the motor control unit 58.

The step-up converter 60 includes a reactor, a switching element, and the like (not shown). The step-up converter 60 is a step-up/step-down circuit having a function of boosting the voltage of the high-voltage battery 46 and supplying the voltage to the inverter 62, and a function of stepping down the voltage converted into a direct current by the inverter 62 and supplying the stepped-down voltage to the high-voltage battery 46.

The inverters 62 include a MG1 power module 64, a MG2 power module 66, and the like. MG1 power module 64 and MG2 power module 66 each include a switching device (not shown) and the like. MG1 power module 64 is connected to the first motor MG1 via a terminal block 84. MG2 power module 66 is connected to the second motor MG2 via a terminal block 86. The terminal block 84 and the terminal block 86 are fixed to the partition wall 72d1, respectively, and are for connecting a connecting line through which a three-phase alternating current for driving the motor MG is supplied between the upper space U and the lower space L. The partition wall 72d1, the upper space U, and the lower space L will be described later. The lower space L (a motor chamber L1 described later) is oil-tightly scaled by the terminal block 84 and the terminal block 86. The inverter 62 converts the DC current outputted from the step-up converter 60 into an AC current for driving the motor MG. The inverters 62 convert the alternating current generated by the motor MG into direct current. The inverter 62 uses the electric power generated by the first motor MG1 as electric power for driving the second motor MG2 in accordance with the running condition.

The electronic control unit 50, the engine control unit 52, and the motor control unit 58 are controllers each including a control device that controls each unit in the vehicle 10. The electronic control unit 50, the engine control unit 52, and the motor control unit 58 are configured to include, for example, a so-called microcomputer in which a CPU performs a signal-processing in accordance with a program stored in a ROM in advance while using a RAM temporary storage function.

The electronic control unit 50 transmits and receives signals to and from DCDC converters 56, the motor control unit 58, and the engine control unit 52 via, for example, a known CAN (Controller Area Network) communication line. The electronic control unit 50 controls the traveling state of the vehicle 10 based on a signal from, for example, a sensor (not shown). The electronic control unit 50 lowers the voltage of the high-voltage battery 46 to a voltage equivalent to that of the auxiliary battery 48, for example, by controlling DCDC converters 56. In this embodiment, the electronic control unit 50 and the engine control unit 52 are each a control unit separate from the motor control unit 58, in particular, PCU54.

The motor control unit 58 controls the motor MG based on the required power from the electronic control unit 50. For example, the motor control unit 58 controls the step-up converters 60 and the inverters 62 to control the respective outputs of the motor MG.

Return to FIG. 1. The transaxle 82 is a drive device including a power transmission device 16 (such as the power split mechanism 40), a first motor MG1, and a second motor MG2. Note that the “transaxle 82” corresponds to the “drive device” in the present disclosure. The drive unit 80 is a unit in which the transaxle 82 and PCU54 are housed in the same case 18 and are integrated, that is, an electromechanical integrated unit.

The meaning of “the same case” will now be described. The case 18 is made of, for example, an aluminum alloy casting, and includes a first case portion 70, a second case portion 72, a third case portion 74, and a fourth case portion 76.

The first case portion 70 is a bottomed cylindrical member. The first case portion 70 has an opening portion 700 (see FIG. 2) on one side opposite the cylindrical engine 12. The second case portion 72 includes a bottomed cylindrical lower portion 72L and a box-shaped upper portion 72U, and a partition 72d1 is provided between the upper portion 72U and the lower portion 72L. In the second case portion 72, a portion above the partition wall 72d1 and the partition wall 72d1 is an upper portion 72U, and a portion below the partition wall 72d1 and the partition wall 72d1 is a lower portion 72L. For example, the second case portion 72 is integrally formed by casting. The space in the lower portion 72L of the second case portion 72 is separated into one side and the other side of the cylindrical shape by the partition wall 72d2. The lower portion 72L has an opening portion 7201 (see FIG. 2) and an opening portion 7202 (see FIG. 2) on the one side, which is the side of the cylindrical engine 12, and the other side, which is the opposite side of the engine 12. An upper portion 72U of the second case portion 72 has an opening portion 7203 (see FIG. 2) on an upper surface thereof.

The first case portion 70 and the second case portion 72 are integrally connected by a fastener such as a bolt 78a so that the opening portion 700 of the first case portion 70 and the opening portion 7201 of the lower portion 72L of the second case portion 72 are closed to each other. The “opening portion 700” and the “opening portion 7201” correspond to the “opening portion of the first case portion” and the “one opening portion of the lower portion”, respectively.

The third case portion 74 is a plate-shaped member joined to the second case portion 72 so as to close the opening portion 7202 of the second case portion 72. Note that the “opening portion 7202” corresponds to the “other opening portion of the lower portion” in the present disclosure. The second case portion 72 and the third case portion 74 are integrally connected by a fastener such as a bolt 78b. The opening portion 700 of the first case portion 70 and the opening portion 7201 of the lower portion 72L are connected by a bolt 78a so as to be closed with each other, and the third case portion 74 is connected by a bolt 78b so as to close the opening portion 7202 of the lower portion 72L. Accordingly, the inside of the lower portion 72L is separated into a motor chamber L1 and a gear chamber L2. The motor chamber L1 is a space surrounded by the third case portion 74 and the other side of the lower portion 72L, which is opposite to the cylindrical engine 12. The gear chamber L2 is a space surrounded by the first case portion 70 and one side of the lower portion 72L, which is the cylindrical engine 12 side. The engine 12 side of the motor chamber L1 and the engine 12 of the gear chamber L2 have the same partition wall 72d2.

The fourth case portion 76 is a plate-shaped member joined to the second case portion 72 so as to close the opening portion 7203 of the upper surface of the second case portion 72. The “opening portion 7203” corresponds to the “upper opening portion” in the present disclosure. The second case portion 72 and the fourth case portion 76 are integrally connected by a fastener such as a bolt 78c. Each of the bolts 78a, 78b, 78c corresponds to a “fastener” in the present disclosure.

Here, a part surrounding the upper space U in the case 18 is referred to as an upper case portion 18U (in the present embodiment, the upper portion 72U of the second case portion 72 and the fourth case portion 76). A part surrounding the lower space L in the case 18 is referred to as a lower case portion 18L (in the present embodiment, the first case portion 70, the lower portion 72L of the second case portion 72, and the third case portion 74). In the up-down direction, the lower case portion 18L is a portion provided below the upper case portion 18U in the case 18. The lower portion of the upper case portion 18U and the upper portion of the lower case portion 18L have a common partition wall 72d1. Therefore, when the upper case portion 18U and the lower case portion 18L are separated from each other, the inside of at least one of the upper case portion 18U and the lower case portion 18L is always exposed to the outside. The “same case” means a case in which, when the upper case portion 18U and the lower case portion 18L are separated as described above, at least one of the inside portions is exposed to the outside.

PCU54 is accommodated in the upper case portion 18U and the transaxle 82 is accommodated in the lower case portion 18L while being mounted on the vehicles 10. The first motor MG1 and the second motor MG2 of the transaxle 82 are accommodated in the motor chamber L1, and the power split mechanism 40 and the like are accommodated in the gear chamber L2. The power split mechanisms 40 and the like accommodated in the gear chamber L2 correspond to “gears” in the present disclosure.

Incidentally, the first resolver 92 and the second resolver 94, which are sensors for detecting the rotational conditions (rotational speed, rotational position, and the like) of the first motor MG1 and the second motor MG2, respectively, are disposed in the motor chamber L1. That is, the first resolver 92 and the second resolver 94 are mounted in the motor chamber L1. For example, the first resolver 92 is a well-known configuration including a resolver stator 92s and a resolver rotor 92r. The resolver stator 92s includes a laminated steel sheet in which a plurality of annular-shaped electromagnetic steel sheets are laminated, and a coil portion for detecting rotation provided at an inner peripheral edge portion of the laminated steel sheet, and a resolver rotor 92r is disposed at a slight gap on an inner peripheral side of the coil portion. The resolver rotor 92r includes a laminated steel sheet in which a plurality of annular-shaped electrical steel sheets having an elliptical or oval outer peripheral surface are laminated, and is attached to the rotor of the first motor MG1 so as not to be relatively rotatable. For example, the second resolver 94 includes a resolver stator 94s and a resolver rotor 94r similar to the resolver stator 92s and the resolver rotor 92r in the first resolver 92, respectively. The resolver rotor 94r is mounted to the rotor of the second motor MG2 so as not to be relatively rotatable. In particular, in a case where the first resolver 92 and the second resolver 94 are not particularly distinguished from each other, they are referred to as a resolver 90. The “resolver 90” corresponds to the “resolver” in the present disclosure. A wire harness 96 is provided between the resolver 90 and PCU54. The wire harness 96 is configured to transmit a signal detected by the resolver 90 to PCU54. The “wire harness 96” corresponds to the “wiring” in the present disclosure.

The wire harness 96 extends from the first resolver 92 and the second resolver 94 in the motor chamber L1 in the axis C1 direction of the first motor MG1 and the axis C2 direction of the second motor MG2, respectively. The wire harness 96 is bent toward the motor control unit 58 accommodated in the upper portion 72U in the gear chamber L2 after the partition walls 72d2 are respectively inserted. Preferably, the wire harness 96 extends along the partition wall 72d2 in the gear chamber L2 toward the motor control unit 58. The wire harness 96 is connected to the motor control unit 58 provided in PCU54 after the opening portion 88 provided in the partition wall 72d1 is inserted therethrough (see FIG. 2). For example, an O-ring (not shown) is sandwiched between the opening portion 88 and the wire harness 96, so that the gear chamber L2 is oil-tightly sealed. Preferably, the wire harness 96 is bundled in the gear chamber L2 such that a detection signal from the first resolver 92 is sent to PCU54 and a detection signal from the second resolver 94 is sent to PCU54.

According to this embodiment, the wire harness 96 for sending a detection signal in the first resolver 92 and the second resolver 94 to PCU54 from the second resolver 94 is a rotation sensor of the first resolver 92 and the second motor MG2 of the first motor MG1 is arranged only in the case 18. Compared to the case of placing the wire harness 96 outside the case 18, when placed only in the case 18, it is possible to shorten the length of the wire harness 96. As a result, for example, it is possible to improve the mountability of the drive unit 80 on the vehicle 10 and to suppress an increase in cost of the drive unit 80.

According to the present embodiment, (a) the case 18 includes the first case portion 70, the second case portion 72, the third case portion 74, and the fourth case portion 76. (b) The first case portion 70 is a bottomed cylindrical member. (c) The second case portion 72 has a box-shaped upper portion 72U and a cylindrical lower portion 72L, and a border between the upper portion 72U and the lower portion 72L is a common partition wall 72d1, and the upper portion 72U is a member having an opening portion 7203 in which the opening portion 700 of the first case portion 70 and one opening portion 7201 of the lower portion 72L are connected by a bolt 78a so as to be closed with each other. (d) The third case portion 74 is a member connected by a bolt 78b so as to close the other opening portion 7202 of the lower portion 72L of the second case portion 72. (e) The fourth case portion 76 is a member connected by a bolt 78c so as to close the opening portion 7203 of the upper portion 72U of the second case portion 72. (f) PCU54 is accommodated in the upper portion 72U of the second case portion 72. (g) The first resolver 92, the second resolver 94, and the wire harness 96 are disposed only in the second case portion 72. PCU54 is accommodated in the upper portion 72U of the second case portion 72. Therefore, the first resolver 92, the second resolver 94, and the wire harness 96 are collectively disposed in the second case portion 72, so that the length of the wire harness 96 can be shortened as compared with the case where the first resolver 92, the second resolver 94, and the wire harness 96 are not collectively disposed. Thus, for example, as compared with the case where the wire harness 96 is disposed in the case 18 other than the second case portion 72 (for example, in the first case portion 70), a connector or the like for connecting from the inside of the second case portion 72 to the inside of the other case 18 becomes unnecessary. Therefore, an increase in cost for arranging the wire harness 96 is suppressed.

According to the present embodiment, (a) the inside of the lower portion 72L, the opening portion 700 of the first case portion 70 and one opening portion 7201 of the lower portion 72L are connected by a bolt 78a so as to be closed to each other, and the third case portion 74 is connected by a bolt 78b so as to close the other opening portion 7202 of the lower portion 72L, the motor chamber L1 in which the motor MG is housed, the gear chamber L2 in which the power split mechanism 40 and the like are housed is separated. (b) The first resolver 92 and the second resolver 94 are disposed in the motor chamber L1. (c) The wire harness 96 is connected to a PCU54 accommodated in the upper portion 72U from the inside of the motor chamber L1 through the inside of the gear chamber L2. Accordingly, when the wire harness 96 is disposed only in the second case portion 72, the difficulty of disposing the wire harness 96 while avoiding the first motor MG1 and the second motor MG2 due to the arrangement of the first motor MG1 and the second motor MG2 accommodated in the motor chamber L1 is reduced. Therefore, it is easy to dispose the wire harness 96 only in the second case portion 72.

It should be noted that the above-described embodiments of the present disclosure are examples of the present disclosure, and the present disclosure can be implemented in various modifications and improvements based on the knowledge of a person skilled in the art without departing from the gist thereof.

In the above-described embodiment, the wire harness 96 is connected from the inside of the motor chamber L1 to PCU54 accommodated in the upper portion 72U through the inside of the gear chamber L2, but the present disclosure is not limited thereto. For example, the wire harness 96 may be connected to a PCU54 accommodated in the upper portion 72U without passing through the inside of the gear chamber L2 from the inside of the motor chamber L1.

In the above-described embodiment, the first resolver 92, the second resolver 94, and the wire harness 96 are disposed only in the second case portion 72, but the present disclosure is not limited thereto. For example, the wire harness 96 may be disposed in the second case portion 72 and the first case portion 70.

In the above-described embodiment, the drive unit 80 includes two motors of the first motor MG1 and the second motor MG2, and the rotational status of each of the first motor MG1 and the second motor MG2 is detected by the first resolver 92 and the second resolver 94. For example, the drive unit 80 may include only one motor, and the rotation state of the motor may be detected by one resolver.

What is claimed is:

1. A drive unit in which a drive device including a motor and a gear and a power control device that controls power transmitted and received by the motor are housed in an identical case, wherein a wire for sending a detection signal from a resolver, as a sensor for rotation of the motor, to the power control device is disposed only in the case.

2. The drive unit according to claim 1, wherein:
the case includes a first case portion, a second case portion, a third case portion, and a fourth case portion;
the first case portion is a bottomed cylindrical member;
the second case portion is a member including a box-shaped upper portion and a cylindrical lower portion with a common partition wall provided at a boundary between the upper portion and the lower portion, the second case portion being coupled by a fastener such that an opening portion of the first case portion and one opening portion of the lower portion close each other, and the upper portion having an opening;
the third case portion is a member coupled by a fastener so as to close another opening portion of the lower portion of the second case portion;
the fourth case portion is a member coupled by a fastener so as to close the opening of the upper portion of the second case portion;
the power control device is housed in the upper portion of the second case portion; and
the resolver and the wire are disposed only in the second case portion.

3. The drive unit according to claim 2, wherein:
the second case portion is coupled by a fastener such that an opening portion of the first case portion and one opening portion of the lower portion close each other, and the third case portion is coupled by a fastener so as to close the other opening portion of the lower portion, so that an inside of the lower portion is divided into a motor chamber in which the motor is housed and a gear chamber in which the gear is housed;
the resolver is disposed in the motor chamber; and
the wire extends from an inside of the motor chamber by way of an inside of the gear chamber to be connected to the power control device housed in the upper portion.
